(19) United States
(12) Patent Application Publication
(10) Pub. No.: US 2012/0010852 A1
(43) Pub. Date: Jan. 12, 2012

(54) METHOD FOR MONITORING WIND TURBINES

(75) Inventors: Jörg Winkelmann, Wardow (DE); Martin Huhn, Polchow (DE)

(73) Assignee: Suzlon Energy GMBH, Rostock (DE)

(21) Appl. No.: 13/254,236

(22) PCT Filed: Mar. 2, 2010
(86) PCT No.: PCT/EP2010/001278

§ 371 Date: Sep. 1, 2011

(30) Foreign Application Priority Data
Mar. 2, 2009 (EP) 09002955.4

(51) Int. Cl. G06F 15/00; G06F 17/18

(52) U.S. Cl. 702/179; 702/183

(57) ABSTRACT

A method for determining damage to a rotor blade of a wind turbine, includes at least the following time-domain-analysis steps: measuring the vibrations of a rotor blade by means of an acceleration sensor; obtaining event-time intervals, in which the amplitudes of the measurements steadily exceed a threshold; obtaining the number of these event-time intervals in at least a predetermined analysis time interval; and sending an error signal, when the obtained number of the event-time intervals is above a predetermined threshold for a predetermined analysis time interval.

### FIELD OF THE INVENTION

The invention relates to a method for monitoring at least one wind turbine, a device and a system for monitoring at least one wind turbine.

### BACKGROUND OF THE INVENTION

For the cost saving operation of wind turbines or wind parks, it is important to determine defects and cracks in the rotor blades of wind turbines as early as possible. Only by the timely detection of the defects, it would be possible to keep the necessary repair costs low and to avoid consequential damage.

A possible way to determine the defects and cracks in the rotor blades is to monitor the state of the rotor blades by means of frequent, visual checks on spot.

However, such visual checks are expensive and thus undesirable. Since defect or broken blades in operation cause vibrations within the rotor blade, methods, according to which the state of a rotor blade can be automatically checked, are known in the prior art.

Such methods must be capable of distinguishing the vibrations resulting from the damage to rotor blade, from those vibrations that result from operation noise, pitch noise and other noise emissions in the wind turbines.

To accomplish this, complicated algorithms are usually used in the methods known in the prior art.

DE 100 65 314 B4 discloses a method for monitoring the state of rotor blades on the wind power plant. Herein, the measurements are firstly converted into electrical signals, and then experienced a spectral analysis and then compared with a spectrum library in a mass storage. A damage signal will be output, if the spectrum of the rotor blade, that is to be monitored, is in correspondence with the spectrum patterns in the spectrum library, which characterize defect rotor blades.

Similarly, US 2010/00 21297 A1 discloses a method for detecting damage in a rotor blade, wherein the measurements of a rotor blade are compared with another blade of the same wind turbine so as to detect the possible damage of a rotor blade with the help of a difference between the measurements.

Since the methods in the prior art includes complex computational operations, expensive and disturb-sensitive computers are usually required to implement them. Moreover, a library of comparative data is often necessary in order to perform the algorithms used in the methods in the prior art.

### SUMMARY OF THE INVENTION

The aim of the invention is to provide a method for detecting the damage to rotor blade, which can be realized in a simple, cheap and less disturb-sensitive hardware device. Besides, the task also lies in providing another method for detecting the damage to rotor blade.

This task is solved by a method with steps according to claim 1 of the patent application and by a device and a system for monitoring wind turbines according to claim 12 and 14 respectively.

Herein, according to the invention, the method for detecting the damage to rotor blade includes analysis steps, which are exclusively carried out in time domain.

In order to determine the state of a rotor blade, the vibrations of at least one rotor blade are firstly measured with the help of at least one acceleration sensor at a sampling rate of preferably at least 5 kHz, more preferably 10 kHz, and transmitted as measurements to an analysis unit. In the analysis unit, event-time intervals are then firstly obtained, in which the amplitude of measurements lies steadily above a predetermined threshold. These event-time intervals are counted. In a subsequent step, the number of these event-time intervals is compared with at least one threshold for the number of event-time intervals in at least one predetermined analysis time interval. If the number of counted event-time intervals lies above the threshold of the analysis time interval, an error message for the analyzed rotor blade will be output.

Preferably, the measurements are led through a low pass filter before the event-time intervals are obtained, so as to apply the subsequent obtainment of the event-time intervals only on the low-frequency measurement component. Particularly preferably, for this purpose a filter of 400 Hz, particularly preferably a filter of 180 Hz, is used.

According to an embodiment of the invention is the threshold for obtaining the event-time intervals is between 1.2 m/s² and 1.6 m/s² and preferably 1.4 m/s². According to another embodiment of the invention, the threshold for obtaining the event-time intervals is not related to a fixed threshold, but a dynamic threshold. If a dynamic threshold is used, the threshold is preferably 5 times the value of averaged vibration measurements of the analysis time interval of a previous time period of preferably 10 seconds and particularly preferably 10 times the value of the averaged vibration measurements of a previous time period of preferably 10 seconds or preferably 10 times the value of the averaged vibration measurements of the previous analysis time interval. According to another embodiment, the dynamic threshold corresponds to the multiple times of the value of the averaged vibration measurements of a previous time period of preferably 10 seconds or of the previous analysis time interval, wherein the multiple times is a predetermined factor of 5 to 10

Preferably, the analysis time interval is between three and seven, particularly preferably between 4 and 6 minutes.

According to another embodiment, the threshold for the number of the counted event-time intervals is selected, so that it lies between 0.3 times and 0.5 times the value of the rotations of the wind turbine in the analysis time interval and preferably corresponds to 0.4 times the value of rotations of the wind turbine in the analysis time interval.

If the analysis time interval corresponds to for example 5 minutes, then the threshold for the number of the counted event-time intervals preferably corresponds to 10, when the rotary speed of the wind turbine corresponds to 5 revolutions per minute (rev/min).

Accordingly, if more than 10 event-time intervals are counted within an analysis time span of 5 minutes at a rotary speed of 5 rev/min of the wind turbine, an error message will be output.

According to another embodiment of the invention, an error message is output only when the number of event-time intervals counted in an analysis time interval is not only above the aforementioned threshold, but also below a second upper threshold at the same time. The upper threshold for the number of the counted event-time intervals is preferably selected to correspond to a value between 2.5 times and 3.5 times the value of the rotations of the wind turbine in the analysis time interval, and preferably 3 times the value.

If the analysis time interval corresponds to for example 5 minutes, the threshold for the number of the counted event-time intervals preferably corresponds to 75, when the rotary speed of the wind turbine is 5 rev/min.

According to a further embodiment of the invention, the threshold/the thresholds for the number of the counted event-time intervals in an analysis time interval is/are not related to fixed values but dynamic values, which is/are adapted to the rotation according to the number measured in the analysis time interval.

According to a further embodiment of the invention, the time distance between the event-time intervals obtained in the analysis time interval will be obtained and a further analysis will be applied: if the time distance between two successive event-time intervals is smaller than the average time distance between two successive event-time intervals in the analysis time interval and a difference between the time distance between two successive event-time intervals and the average time distance of successive event-time intervals is larger than a given threshold in amount, these event-time intervals will not be counted or the threshold for the number of the event-time intervals in the analysis time interval is upward adapted by a counter.

According to a further varied embodiment, the duration of an event-time interval will be obtained and compared with a pregiven threshold for the duration of event-time intervals. If the obtained duration of an event-time interval is lower than this threshold, this event-time interval will not be counted. Preferably, such a threshold is between 0.1 and 0.3 seconds.

Surprisingly, it has been shown that vibrations caused by a damage to rotor blade often occur particularly when a rotor blade just passes the 12 o'clock position. Accordingly, preferably only such event-time intervals will be counted, which are obtained when the position of a rotor blade is between the 12:00 o'clock position and the 6:00 o'clock position.

In this case, however, the thresholds for the number of the event-time interval obtained in the analysis time interval must be reduced, because—if statistically not so often—vibrations that are caused by damage of a rotor blade, also occur in a position of the rotor blade between 6:00 clock position and the 12:00 clock position.

It has been shown that the average number of the vibrations, which are obtainable during one revolution and are caused by a damaged rotor blade, on the one hand depends on the wind speed and on the other hand depends on the operation state of the wind turbine—“free wheel mode” or “power generation mode”. The reason for this is that the cracks in the rotor blades partly close by the load of the wind turbine and in particular by bending back the rotor blades in wind direction and thus no characteristic vibration will be obtained.

Accordingly, the method for detecting the damage to rotor blade, according to another embodiment of the invention includes method steps, which cause the wind turbine, whose rotor blades are to be examined, to be driven within the analysis time interval in an analysis mode or a test mode.

Herein, the rotary speed is set to be a given analysis rotary speed, which is preferably between 4 and 6 rev/min and is preferably 5 rev/min, before the analysis time interval begins. Only slight variation ranges of the rotary speed are allowed for the test mode. To avoid any disturbing noises resulting from the pitch drives, the pitch-automatic is shut down during the analysis time interval or the maximum pitch—speed is limited to a minimum of preferably less than 3 degrees per second.

If the desired analysis mode can not be kept, then the method for detecting the damage to rotor blade comprises one step of interrupting or terminating the analysis and of resuming the method at a later, more proper time point. The analysis mode can not be kept, for example, if the measured wind speed is too high or too low.

If an analysis mode can not be carried out, because the wind speed is too high, the wind turbine is shut down, preferably after exceeding a given allowable time delay. Preferably, a test is then initiated at a later time point, as soon as the allowable wind speed of preferably less than 18 m/s prevails.

According to a further embodiment, the method comprises a start function, which causes the separate steps of the method to be carried out not continuously, but preferably only once every 1 or 2 days, ie, the analysis mode will also only be started every 1 or 2 days. According to a further embodiment, the turbine will be shut down in the presence of an error signal and the error signal will be transmitted to an external remote maintenance location in which an error message and/or measurements are output via an output unit. Preferably, the wind turbine will be restarted after it is shut down for the first time; in the presence of an error signal the wind turbine will be shut down again and will not be automatically restarted any more. The error signal is preferably transmitted again to a remote maintenance location.

Particularly if the method steps of initiating and maintaining an analysis mode in the analysis time interval are abandoned, it is helpful and therefore configured according to further embodiments of the invention, that the method steps carried out in frequency domain, in frequency-time domain or in probability domain are located before besides, and after the method steps performed in time domain,

According to further embodiments of the invention, one or more following analysis steps are set.

Preferably, the kurtosis of the curve of the measurements in the event-time intervals will be calculated and compared with predetermined thresholds for the kurtosis. Preferably, the measurements used are not the filtered measurements, but the unfiltered measurements.

Preferably, an event-time interval will not be counted if the kurtosis—the Gaussian normal distribution will be assumed at a kurtosis of 3—of the event-time interval is greater than a predetermined value between 10 and 25. According to another embodiment, the kurtosis for a time span between 0.3 and 0.6 seconds and preferably of 0.5 seconds after the start of the event-time interval is calculated, regardless of the actual size of the event-time interval.

According to another embodiment, not only the kurtosis of the entire event-time interval or a time span between 0.3 and 0.6 seconds is determined, but also the kurtosis of given time periods of the event-time interval is determined, wherein the event-time interval is preferably divided into periods with the same size, or into such periods between 0.03 and 0.07, preferably of 0.05 seconds. An event-time interval is also then preferably not counted if the kurtosis of one or more of these periods is over a threshold of 4 to 10.

It has been shown that the ratio of the kurtosis of separate periods of the event-time interval to the kurtosis of the entire event-time interval or the ratio of the average kurtosis of the periods of the event-time interval to the kurtosis of the entire event-time interval has a characteristic variable for damaged blades. Accordingly, according to an embodiment, an event-time interval will not be counted, when the ratio of the kurtosis of one or more periods of the event-time interval to the kurtosis of the entire event-time interval, or ratio of the average kurtosis of the periods of the event-time interval to the kurtosis of the entire time interval or the kurtosis of the long time interval is above a threshold between 2.5 and 3.5. Since these kurtosis-analysis steps make an effective method for detecting the damage to rotor blade without the analysis steps in time domain possible, these steps also depict an independent inventive idea without the analysis steps in time domain.

According to a further embodiment, a frequency-synchronicity-method is located before the method steps carried out in time domain.

For this method, the measurements are firstly led through a low pass filter and through a high pass filter of preferably 400 Hz at the same time. If an event-time interval is obtained for the low-frequency measurements components, then it will be checked whether a given threshold for the high-frequency measurements components can be determined at the same time. As has been shown that damaged rotor blades comprise particularly strong deviations in the low frequency domain, if for the high-frequency measurements components a given threshold of preferably 1.4 to 3 m/s² is also exceeded at the same time, it is not related to a vibration, which is caused by a damaged rotor blade and accordingly, the corresponding event-time interval is not counted or the threshold for the number of the event-time intervals is set upwards by a counter. According to a variant, this threshold for the high frequency measurements components is dynamic, wherein the threshold is preferably higher than the threshold for the low frequency measurements components i.e. the factor, with which the dynamic threshold is calculated based on the average measurements of a previous time period, can be selected to be higher for the high frequency measurement components than for the low frequency measurement components.

The average frequency and root mean square (RMS) of the frequency have been proved to be other characteristic variables. Here, the average frequency is calculated by means of FFT method (Fast Fourier Transform) for the event-time domain, or preferably for a time span of 0.5 seconds after the start of the event-time interval using all, not only the filtered measurements components.

For the RMS analysis, the event-time interval or the time span of 0.5 seconds after the start of the event-time interval is preferably divided into at least three periods with the same size and the RMS value preferably of all measurements components is calculated for each period. If not each of the periods in chronological order has a lower RMS value than the previous period, it is not related to vibrations, which are caused by the damage of the rotor blade, such an event-time interval is therefore not counted or the threshold for the number of event-time intervals is set upwards by a counter.

According to another embodiment, a component-synchronicity-method is set before the method steps carried out in time domain. For this method, the fact, that it is very unlikely that a damage to rotor blade occurs simultaneously in several rotor blades of a wind turbine, will be used. Accordingly, if an event-time interval is detected in at least two rotor blades at the same time, the event-time interval is not counted or the threshold for the number of event-time intervals is set upwards by a counter.

According to another embodiment, an error signal will also be output if an analyzing unit is determined to be defect. A defect is preferably determined from the fact that the number of the counted event-time intervals in an analysis time interval is zero or falls below a given threshold.

Another aspect of the invention provides an device for monitoring the damage to rotor blade of the wind turbines, it comprises at least one acceleration sensor and one analyzing unit, wherein the analyzing unit is configured to obtain event-time intervals firstly, in which the amplitude of measurements lies steadily above a predetermined threshold, and is preferably also configured to count the event-time intervals and then output an error message for the analyzed rotor blade, if the number of these event-time intervals lies above a lower threshold for the number of the event-time intervals and below an upper threshold for the number of the event-time intervals in an analysis time interval.

Another aspect of the invention provides a system for monitoring the damage to rotor blade of the wind turbines, it comprises at least one said device, one transmitting unit, one control unit, one computing unit, one central data obtaining device, and one central data output device are available.

The transmitting unit is preferably implemented as slip ring or as WLAN-Bridge and is configured to transmit signals and/or measurements to the control unit and/or the computing unit and/or the central data obtaining device and/or the central data output device. According to the invention, Bachman fastbus and/or other data conductors may be used as a transmitting unit in addition to the ring or the WLAN-Bridge.

Herein, the control unit is configured to control the wind turbine. In contrast to the analyzing unit, the computing unit is configured to also perform the analysis steps in frequency domain and/or analysis steps in frequency-time domain and/or analysis steps in probability domain besides the analysis steps in time domain.

The central data obtaining device is configured to store the measurements, and preferably also the error messages. The central data output device is configured to output an error message centrally for several wind turbines. Preferably, the data output device additionally has a data input interface or is connected therewith. Preferably, via the data input interface, it is possible to access the parameters of the computing unit directly or indirectly and adapt them for future procedures.

In operation, the test mode is preferably initiated by the analyzing unit for a wind turbine and the vibrations of each rotor blade are measured with the help of at least one, preferably several acceleration sensors within a given analysis time interval. After the measurements are preferably firstly filtered via a 180 Hz low-pass filter, the analyzing unit then obtains event-time interval, in which the measurements lie steadily above a given threshold of preferably 1.4 m/s². If an event-time interval is obtained, the analyzing unit transmits the measurements, which lie within the event-time interval—herein however preferably not the filtered values, but the entire spectrum—to the computing unit. In the computing unit, then preferably the kurtosis analysis described above, the analysis of the average frequency using FFT method described above, and the RMS analysis describe above are at least performed. Only those event-time intervals are counted, which satisfy those analysis. Finally, it will be checked whether the counted event-time intervals lie between the above described thresholds for the number of the event-time intervals in an analysis time interval. If so, an error message will be output.

### BRIEF DESCRIPTION OF DRAWINGS

Further details of the invention will become apparent from the drawings in accordance with the descriptions.

In the drawings:

FIG. 1 shows a flow chart of a first embodiment of the method with a time-domain analysis according to the invention,

FIG. 2 shows a flow chart of a second embodiment of the method with a probability and frequency analysis, which is set before the time-domain analysis according to the invention,

FIG. 3 shows a flow chart of a third variant of the method with an analysis mode for the wind turbine according to the invention,

FIG. 4 shows a schematic diagram of the implementation of the method of FIG. 1 in a device and a system for monitoring wind turbines,

FIG. 5 shows a schematic diagram of the implementation of the method of FIG. 1 and/or FIG. 2 in a device and a system for monitoring wind turbines,

FIG. 6 shows a schematic diagram of an implementation of the method of FIG. 1 and/or FIG. 2 in a device and an enhanced system for monitoring wind turbines.

### DETAILED DESCRIPTION OF EMBODIMENTS

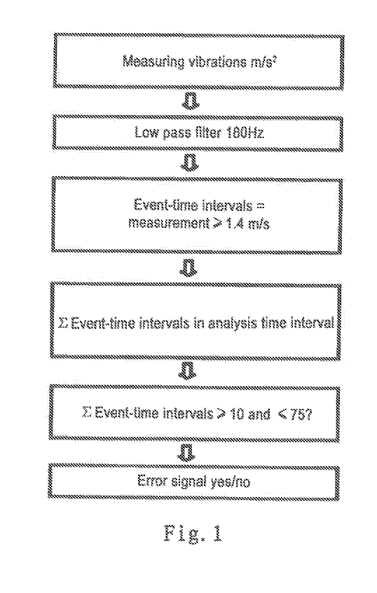

FIG. 1 shows the necessary steps of the method for monitoring the wind turbines 3 according to the invention. In order to examine each individual rotor blade of a wind turbine 3 for the possible damage to rotor blade, the wind turbine is equipped with at least one acceleration sensor 10 that measures the vibrations of each rotor blades with a sampling rate of at least 10 kHz. The measurement results are then led through a low pass filter of 180 Hz.

Time intervals, in which the measurements are steadily higher than 1.4 m/s², are obtained as event-time intervals. The event-time intervals are counted within an analysis time interval of 5 minutes. If the number of the event-time intervals in the analysis time interval is a value between 10 and 75, an error signal will be output.

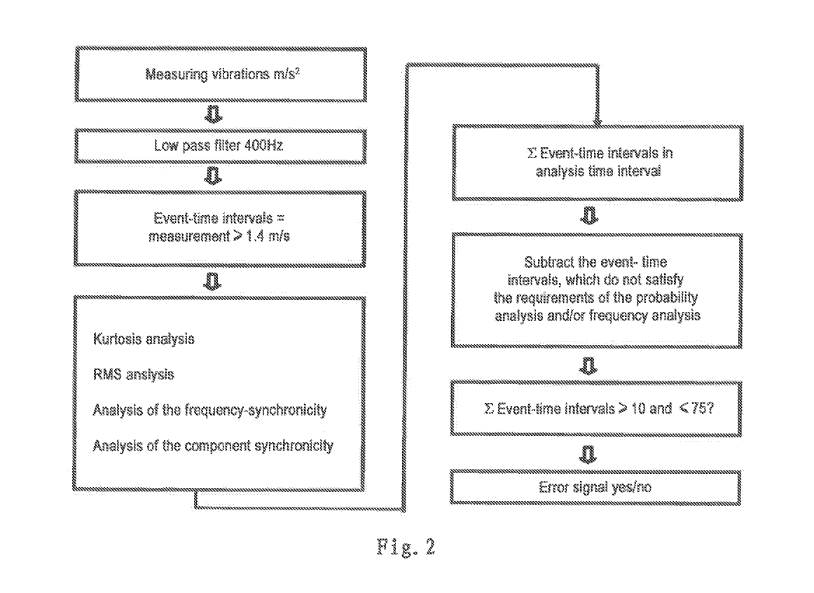

FIG. 2 shows an enhanced embodiment of the method according to the invention, which includes further analysis steps in the probability domain and in frequency-time domain besides the analysis steps in time domain. As the method illustrated in FIG. 1, the vibrations of a rotor blade are firstly measured via a number of acceleration sensors, or via an acceleration sensor. In contrast to the method shown in FIG. 1, the measurements are now led through a low pass filter of 400 Hz. Accordingly, in this embodiment it is less filtered than in the method variant according to FIG. 1. Next, the time intervals, in which the vibrations are greater than 1.4 m/s², are obtained as event-time intervals.

With a kurtosis analysis, the deviation of the measurements in the event-time intervals is determined by the Gaussian normal distribution. The obtained event-time interval is counted, only when the determined kurtosis has a value less than 25.

At the same time the root mean square (RMS) over the frequencies is constructed for 3 periods with the same size of each event time interval and it is checked whether the determined value of the second or third period is lower than the value of the chronologically earlier period. The corresponding event-time interval is counted, only when it is the case.

Then the average frequency in the event-time interval is calculated by means of FFT method and it is checked whether the determined value is below a given threshold. The event-time interval is counted, only when it is the case.

Then an analysis of frequency-synchronicity is performed. It is therefore necessary that the measurements are initially led through a high pass filter in addition to a low pass filter, since it is checked in the frequency-synchronicity, whether there is a threshold of 3 m/s² for the high-frequency measurements components at the time point when the event-time interval is obtained. If it is the case, it can be assumed that the vibrations are not those caused by the damages to rotor blade. Consequently, such an event time interval is not counted.

Next, an analysis of the component-synchronicity is performed. When an event-time interval is obtained at one rotor blade, if an event-time interval is obtained at another rotor blade at the same time, it can be assumed that the vibrations are not those caused by the damages to rotor blade. Accordingly, such an event time interval is not counted. All other obtained event-time intervals are counted within the analysis time interval of 5 minutes. If the determined number of the event-time intervals in the analysis time interval lies between 10 and 75, an error signal will be output.

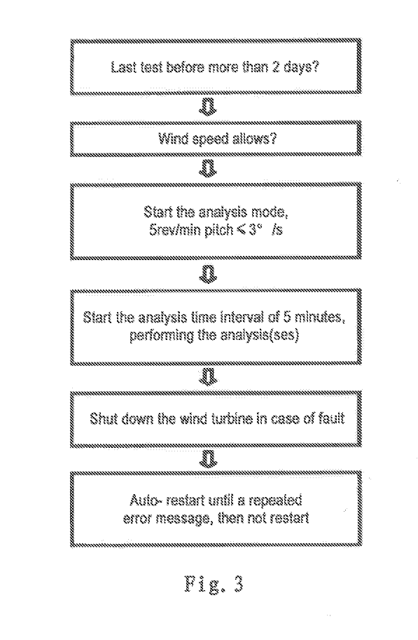

FIG. 3 shows another variant of the method, which still has steps for initiating an analysis mode, and for maintaining an analysis mode during the analysis time interval in addition to the variant shown in FIG. 1 or 2. In this variant it will be firstly checked, how long has it been since the last test for checking the wind turbine for the damage to rotor blade is completed. If the last test was conducted more than two days before, and at the same time the average wind speed in 10 minutes lies between 18 m/s and 3.5 m/s, the analysis mode is initialized. This means that the wind turbine is set to a rotary speed of 5 rev/min, and a pitch speed of less than 3 degrees per second is kept. The wind turbine produces no current in analysis mode. If a pitch speed of more than 3 degrees per second is necessary due to the weather conditions, the test is aborted and resumed at a later time point. If the analysis mode can be maintained during the analysis time interval, the analyses according to FIG. 1 or FIG. 2 are carried out and an error message is then output when the number of the counted event-time intervals lies between 10 and 75. If so, the wind turbine is firstly shut down, and then turned on again by an Auto-restart and operates until a new error message is output. If the wind turbine is shut down for a second time, it will not be turned on by an Auto-restart.

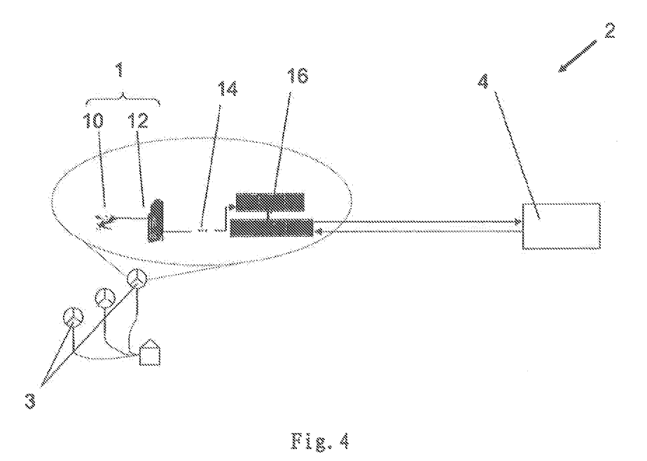

FIG. 4 shows the implementation of the method of FIG. 1 in a device 1 and a system 2 for monitoring the wind turbines 3. Herein, the device 1 comprises a sensor 10 and an analyzing unit 12 for each rotor blade. The system 2 for monitoring the wind turbines 3, comprises the device 1, a slip ring 14, a control unit 16 for controlling a wind turbine 3 and a central data output device 4. Once the analyzing unit 12 recognizes that the last test was conducted more than two days before, the analyzing unit 12 sends a signal to the control unit 16 via the slip ring 14, which is configured to transmit data and signals, whereupon this initiates an analysis mode for the corresponding wind turbine 3 and maintains for the duration of the analysis time interval.

During the analysis time interval, the sensors 10 measure the vibrations of the respective rotor blades and transmit the measurements to the analyzing unit 12. Then the analysis method according to FIG. 1 is implemented in the analyzing unit 12. If an error signal is output, the analyzing unit 12 sends a shut down signal to the control unit 16 via the slip ring 14, whereupon the wind turbine is shut down either immediately or after a short time.

Simultaneously, the error signal and preferably the measurements measured by the sensors 10 as well are transmitted to the central data output device 4. The technicians who are responsible for monitoring the wind turbines are alerted via the data output device and the technicians can preferably monitor the current vibrations and particularly preferably the technicians can avoid shutting down the wind turbine 3 by means of a return signal. When the wind turbine 3 has been shut down due to an error, the analyzing unit 12 sends an auto-restart signal to the control unit 16 via the slip ring 14 so as to restart the wind turbine 3. When the error occurs and is obtained again, the wind turbine 3 will be shut down again and must be manually restarted. An auto-restart will not happen.

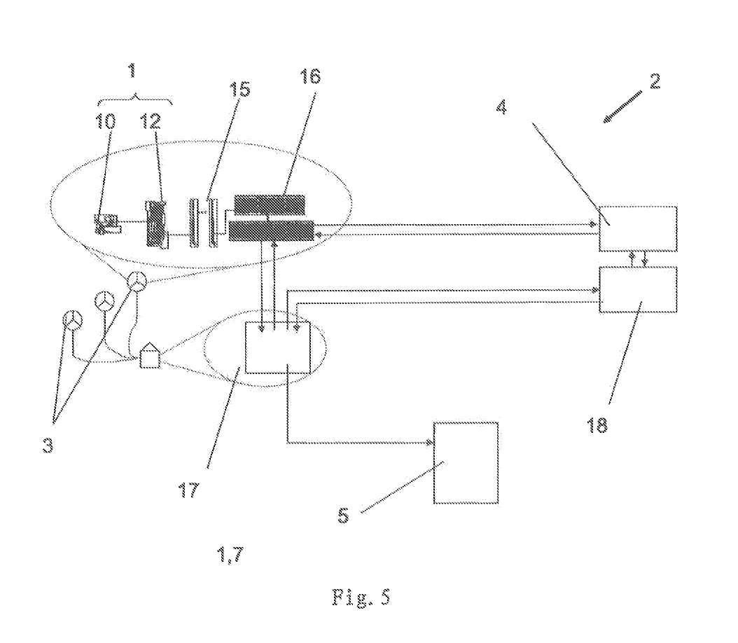

FIG. 5 shows another embodiment of the system 2 for monitoring the wind turbines 3 according to the invention. Unlike the embodiment in FIG. 4, the signals output by the analyzing unit 12 and the measurements transmitted by the analyzing unit 12 are transmitted to the control unit 16 an to a computing unit 17 not via the slip ring 14, but via a WLAN-Bridge 15. Since the computing unit 17 has higher computing power than the analyzing unit 12, the measurements transmitted via the analyzing unit 12 and the WLAN-Bridge 15 are analyzed in the computing unit 17 with the help of the enhanced analysis steps according to FIG. 2. In this case, in terms of the signal for shutting down a wind turbine 3, the control unit 16 only responds to the signals which is output by the computing unit 17, since such signals are based on a preciser analysis of the measurements. The signals for initiating and maintaining the analysis mode and all other signals—except the error signal and the shut down signal—are originated from the analyzing unit 12. The analyzing unit further obtains the event-time intervals and transmits only those measurements which are measured within the event-time interval, here not only the filtered measurements, but also the entire spectrum. Then in the computing unit it will be checked for these event-time intervals, whether there are criteria, which show that an obtained event-time interval is not caused by a damage to rotor blade. If so, this event period is not counted. At the end of all analysis methods, the number of the counted event-time intervals is compared with the thresholds 10 and 75, as long as it is related to an analysis time span of 5 minutes at 5 rev/min, and an error signal is output, when the counted event-time intervals lie between these values. If an error signal is also output by the computing unit 17, the wind turbine 3 is shut down. At the same time, the error signal and the measurements are transmitted to a central data obtaining device 5 and saved there.

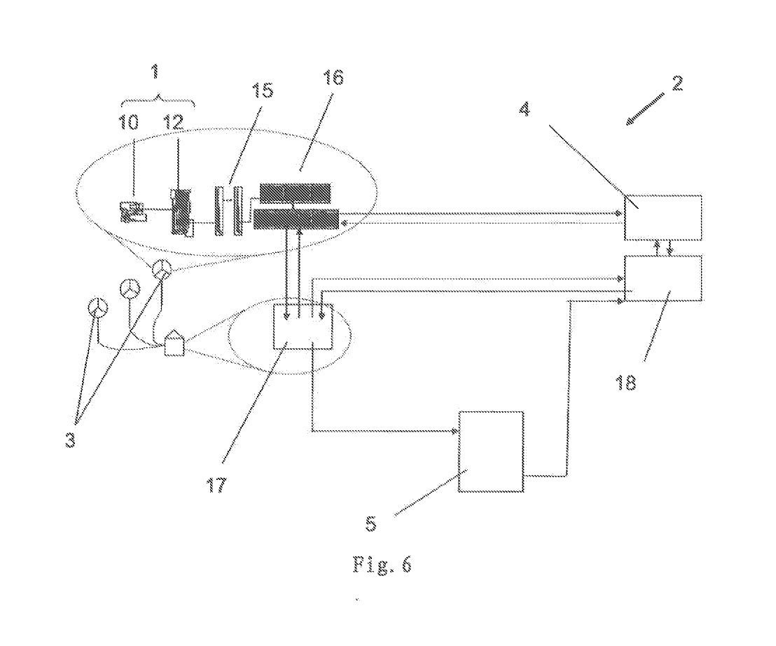

FIG. 6 shows a further embodiment of the system 2 for monitoring the wind turbines 3 according to the invention. Unlike the embodiment shown in FIG. 5, in this embodiment, both the current and the earlier measurements of the computing unit 17 and/or of the data obtaining device 5 can be required via a data input interface 18 connected with the data output device 4, and are then output by means of the data output device 4. Via the data input interface 18, it is also possible to access the parameters of the computing unit 17 directly or indirectly and adapt them for future tests.

The feature combinations disclosed in the described embodiments do not limit the scope of the invention, and the features of different embodiments can rather be combined with each other.

### REFERENCE LIST

1 Device for monitoring the wind turbines
2 System for monitoring the wind turbines
3 Wind turbine(s)
4 output unit
5 data obtaining unit
10 sensor(s)
12 analyzing unit
14 slip ring
15 WLAN-bridge
16 control unit
17 computing unit
18 data input interface

1. A method for determining damage to rotor blade of a wind turbine, comprising at least the following time-domain-analysis steps:
measuring the vibrations of a rotor blade by means of an acceleration sensor,
obtaining event-time intervals, in which the amplitudes of the measurements steadily exceed a threshold,
obtaining the number of these event-time intervals in at least a predetermined analysis time interval,
sending an error signal, when the obtained number of the event-time intervals is above a predetermined threshold for a predetermined analysis time interval.

2. A method according to claim 1, wherein an error signal is sent only when the determined number of the event-time intervals is also under a predetermined upper threshold for a predetermined analysis time interval.

3. A method according to claim 1, wherein during the analysis time interval, the wind turbine is operated in a test mode, in which the wind turbine is in a free wheel mode and in which the rotary speed is kept in a variation range which is not maintained in the normal operation case, and the pitch speed is kept below a maximum value which is not maintained in the normal operation case.

4. A method according to claim 3, wherein only vibrations less than 400 Hz, preferably less than 180 Hz are used for obtaining the event-time intervals.

5. A method according to claim 1, wherein the threshold for obtaining each event-time range is a value between 1.2 and 1.6 m/s² preferably between 1.3 and 1.5 m/s².

6. A method according to claim 1, wherein the threshold for obtaining each event-time range is related to a dynamic threshold, which corresponds to a value between 5 and 15 times of the average measurements of the vibration of a previous, predetermined time interval.

7. A method according to claim 1, wherein an event-time interval is not counted, when its time length is below a given threshold.

8. A method according to claim 1, wherein analysis method steps in frequency domain, in frequency-time domain and/or in probability domain are located before, besides, and after the method steps in time domain.

9. A method according to claim 1, wherein an event-time interval is not counted, when the kurtosis of the curve of the measurements in the event-time interval is above a predetermined threshold.

10. A method according to claim 1, wherein an event-time interval is not counted, when the RMS values of several successive time periods of a event-time interval do not decrease steadily in chronological order.

11. A method according to claim 1, wherein an event-time interval is not counted, when an event-time interval is obtained on a second rotor blade of the wind turbine at the same time.

12. A device (1) for monitoring damage to rotor blade of wind turbines (3) with at least one acceleration sensor (10) and an analyzing unit (12), wherein the analyzing unit (12) is configured to perform a method according to claim 1.

13. A device (1) for monitoring damage to rotor blade of wind turbines (3) according to claim 12, wherein the analyzing unit (12) is configured to perform a routine for initiating a test mode and to output a corresponding signal to a control unit (16) of the wind turbine (3).

14. A system (2) for monitoring the damage to rotor blade of wind turbines (3) with at least one device (1) according to claim 12, a transmitting unit (14, 15), a control unit (16) for controlling a wind turbine (3), a computing unit (17), a central data obtaining device (5), which is configured to store the measurements and error messages, and a central data output device (4).

15. A system (2) for monitoring the damage to rotor blade of wind turbines (3) according to claim 14, wherein the data output device (4) is connected with a data input interface (18), via which, it is possible to access parameter of the computing unit (17) directly or indirectly and adapt them for future methods.
